(19) United States
(12) Patent Application Publication
(10) Pub. No.: US 2025/0271085 A1
(43) Pub. Date: Aug. 28, 2025

(54) Pipe fitting, use of such a pipe fitting and method for the production of a connection between a pipe and such a pipe fitting

(71) Applicant: Schwer Fittings GmbH, Denkingen (DE)

(72) Inventor: Rober Emminger, Königsfeld im Schwarzwald (DE)

(21) Appl. No.: 19/048,124

(22) Filed: Feb. 7, 2025

(30) Foreign Application Priority Data
Feb. 26, 2024 (DE) 10 2024 105 323.2
Feb. 26, 2024 (EP) 24159705.3

(51) Int. Cl. F16L 19/10

(52) U.S. Cl. CPC F16L 19/10

(57) ABSTRACT

A pipe fitting (1) is supposed to comprise a socket (5), a cutting ring (3) and a counter bearing (4), wherein the pipe fitting (1) comprises four cones (13, 14, 16, 17), wherein the cones (13, 14, 16, 17) are dimensioned and arranged in such a way that during the production of the working position, first the first cutting edge (11) and then the second cutting edge (12) cuts into a surface of a pipe end section (2).

### TECHNICAL FIELD

The invention relates to a pipe fitting, a use of such a pipe fitting and a method for the production of a connection between a pipe and such a pipe fitting according to the independent claims.

### PRIOR ART

Pipe fittings are known from the prior art. For example, AT 270316 B shows a pipe fitting consisting of a connector, a sealing ring with several cutting edges and a union nut.

### Problem to be Solved

The object of the present invention is to overcome the disadvantages of the prior art.

### Solution of the Problem

The subjects of the independent claims lead to the solution of the problem. Preferred embodiments are described in the dependent claims.

A preferred embodiment of the present invention relates to a pipe fitting comprising a socket. This socket is configured to receive and support a pipe end section belonging to a pipe and a cutting ring, as well as to at least partially receive a counter bearing. The pipe end section and the cutting ring can be fully inserted into the socket. The counter bearing can, for example, comprise an external thread that is screwed to an internal thread of the socket. Here, the socket preferably does not fully receive the counter bearing. For example, it may be envisaged that an external hexagon of the counter bearing is not arranged within the socket in the working position.

The counter bearing is preferably used to apply a force to the cutting ring and to press it into the socket, while at the same time preventing the cutting ring from leaving the socket.

The pipe fitting is preferably used, as will be explained in more detail below, for the connection of a pipe to other components of a piping system. For example, two pipes can be connected to each other at their pipe ends via the pipe fitting.

The cutting ring and the counter bearing are preferably two separate components. However, it may also be envisaged that the cutting ring and the counter bearing are built as a single-piece component. This single-piece design of the cutting ring and the counter bearing can be permanent. Alternatively, a predetermined breaking point can be provided between the cutting ring and the counter bearing so that both can be deliberately separated from each other during an assembly process, which will be described below.

During assembly, i.e. during the production of a connection between a pipe and the pipe fitting, the counter bearing exerts a force on the cutting ring, preferably along a longitudinal centerline of the cutting ring.

The aforementioned pipe with the aforementioned pipe end is not a mandatory component of the present invention. Rather, the present invention serves to produce a connection between a pipe and the pipe fitting.

The pipe fitting is designed in such a way that the counter bearing and the cutting ring are pushed onto the pipe. This sliding on at the beginning of the assembly makes it possible to arrive at the working position described in more detail below after assembly.

The cutting ring has a first end and a second end. In the working position, the first end is arranged closer to a pipe end of the pipe than the second end.

At least two cutting edges are arranged inside the cutting ring, wherein the first cutting edge is arranged closer to the first end of the cutting ring than the second cutting edge. The same applies to any further cutting edges. For example, if the cutting ring includes a third cutting edge, the second cutting edge is arranged closer to the first end than the third cutting edge.

If, in the context of the present invention, reference is made to a first or second end without further specifying these ends, then, as a rule, the respective ends of the cutting ring are meant.

An outer surface of the cutting ring comprises at least a first external cone and at least a second external cone. The first external cone is arranged closer to the first end of the cutting ring than the second external cone.

Preferably, a contact surface of the cutting ring, which is described in more detail below and which is in contact with a corresponding contact surface of the counter bearing during assembly and in the operating position, forms at least a section of the second end of the cutting ring. Preferably, the first cutting edge forms at least a section of the first end of the cutting ring. In the above cases, there is thus preferably no section of the cutting ring between the first end of the cutting ring and the first cutting edge.

In the working position, the first external cone is arranged closer to the pipe end than the second external cone. The pipe end is preferably that terminal part of the pipe end section that penetrates the deepest into the socket and, in the working position, rests against an end stop inside the socket, for example.

The first external cone forms a smaller angle with a longitudinal centerline of the cutting ring than the second external cone.

An inner surface of the socket includes at least a first internal cone and a second internal cone. The first internal cone forms a smaller angle with a longitudinal centerline of the socket than the second internal cone.

If, in the context of the present invention, reference is made to an internal cone without further specification, this generally refers to the respective internal cone of the socket. If, in the context of the present invention, reference is made to an external cone without further specification, this generally refers to the respective external cone of the cutting ring.

The first internal cone is configured to engage operatively with the first external cone in the working position. The second internal cone is configured to engage operatively with the second external cone in the working position. Herein, a working position is preferably understood to be a condition that is present after proper assembly of the pipe fitting, i.e. when a pipe end section of a pipe has been properly connected to the pipe fitting.

Preferably, there is surface contact between the inner and outer cones in the working position. A surface that forms the first internal cone preferably makes surface contact with a surface that forms the first external cone in the working position. The same applies to the surfaces that form the second internal and external cones. Before and during assembly, line contacts preferably exist first and point contacts in the longitudinal section.

The working position can be produced by the counter bearing moving the cutting ring into the socket, preferably along its longitudinal centerline. Preferably, the longitudinal centerlines of the cutting ring, the socket and the pipe coincide during assembly and in the working position.

The cones are preferably dimensioned and arranged in such a way that during the production of the working position, i.e. during assembly, first the first cutting edge and then the second cutting edge cuts into a surface of the pipe end section. The same applies preferably to any further cutting edges that may be present. For example, if the cutting ring has three cutting edges and the third cutting edge is also supposed to cut into the surface of the pipe end section, the third cutting edge cuts into the surface of the pipe end section after the second cutting edge.

The first cutting edge, arranged close to the first end of the cutting ring, cuts into the surface first, i.e. before the second and any further cutting edges, ensuring that the cutting ring is then compressed and deformed or bent when the counter bearing continues to exert a force on the second end of the cutting ring.

Preferably, the first cones, i.e. the first internal cone and the first external cone, contact each other first during assembly. Preferably, a point or line contact and sliding of the first external cone along the first internal cone occurs first herein, until surface contact of the aforementioned cones has been formed. Preferably, the second cones, i.e. the second internal cone and the second external cone, do not contact each other until after the production of the aforementioned surface contact of the first cones. Surface contact between the second cones is then preferably achieved by enlarging the angle between the second external cone and the longitudinal centerline of the cutting ring by deforming or bending the cutting ring. When establishing surface contact between the first cones, the angle between the first external cone and the longitudinal centerline of the cutting ring is also enlarged, preferably by bending the cutting ring, which at least supports the production of the aforementioned surface contact. In particular, the incorporation of the cutting edges into the surface of the pipe end section can enable and/or effect the production of surface contacts between the inner and outer cones in connection with a bending of the cutting ring.

The cutting edge that first cuts into the surface acts as an anchor and prevents or hinders a translational movement of the cutting ring along the longitudinal centerlines of the cutting ring and socket. After the cutting edge that first cuts into the surface has cut in, the cutting ring is compressed and deformed between this cutting edge and its second end. The section between the first end of the cutting ring and the first cutting edge, if there is one, is hardly subjected to any forces or deformation after this initial cutting. If the first cutting edge, as is the case with the pipe connection according to AT 270316 B, is not the cutting edge closest to the first end of the cutting ring, the cutting edges between the first end of the cutting ring and the first cutting edge to cut in are not applied with sufficient force to cut sufficiently deep into the surface of the pipe.

The cutting ring can include exactly two cutting edges. The cutting ring can also include exactly three or more than three cutting edges. The number of outer cones of the cutting ring does not have to correlate with the number of cutting edges. However, there are at least two outer cones and at least two cutting edges. Variants of the cutting ring with exactly two outer cones and two or three cutting edges are preferred.

Optional details and further embodiments are described below, which may be considered based on the embodiment described above.

The socket can have an internal thread that corresponds to an external thread of the counter bearing. The counter bearing is preferably a hollow screw. When the present invention refers to a counter bearing, a hollow screw can always preferably be envisaged. It is therefore preferred that the hollow screw or, in general, the counter bearing is screwed into the socket and thereby presses the cutting ring into the socket, so that the cutting edges of the cutting ring, starting with the first cutting edge, work their way into the surface of the pipe end section located in the socket. If the cutting ring has more than two cutting edges, then at least the first and second cutting edges preferably cut into the pipe end section one after the other. At the same time, during this screwing in of the counter bearing, the inner and outer cones preferably come into surface-to-surface contact with each other, which is described in more detail below. The design of the inner and outer cones preferably supports or causes the cutting edges to engage in the pipe end section in the desired sequence, starting with the first cutting edge.

The pipe fitting may comprise the socket, the cutting ring and the counter bearing as separately manufactured components or consist of these components. The pipe fitting can thus be a system comprising at least three parts or exactly three parts.

The angle between the first internal cone and the longitudinal centerline of the socket may be greater than the angle between the first external cone and the longitudinal centerline of the cutting ring. The angle between the second internal cone and the longitudinal centerline of the socket can be greater than the angle between the second external cone and the longitudinal centerline of the cutting ring. The size relationships of the angles described above result in point or line contact between the first cones during assembly, which changes to surface contact when the first cutting edge cuts into it. Point or line contact then occurs between the second cones, which changes to surface contact at the latest when the working position is reached. Usually, line contacts arise during the assembly process described above, which appear as point contacts in a sectional view. However, it is also conceivable that, for example, point contacts initially exist between the inner and outer cones, followed by line contacts, which then change into surface contacts.

The angle between the first external cone and the longitudinal centerline of the cutting ring can be between 10° and 24°, preferably between 13° and 21°, more preferably between 15° and 19°. The aforementioned angle can be approximately or exactly 17°.

The angle between the second external cone and the longitudinal centerline of the cutting ring can be between 20° and 35°, preferably between 22° and 32°, more preferably between 24° and 29°, more preferably between 25° and 27°. The aforementioned angle may be approximately or exactly 26°. Herein, the angle between the second external cone and the longitudinal centerline of the cutting ring is preferably greater than the angle between the first external cone and the longitudinal centerline of the cutting ring.

The angle between the second external cone and the longitudinal centerline of the cutting ring can be between 2° and 15° greater than the angle between the first external cone and the longitudinal centerline of the cutting ring. It may also be envisaged that the first-mentioned angle is greater than the second-mentioned angle by between 4° and 12° or between 6° and 11°, and more preferably between 8° and 10°, and particularly preferably approximately or exactly 9°.

The angle between the first internal cone and the longitudinal centerline of the socket can be between 17° and 31°. This angle can preferably be between 20° and 28° or between 22° and 26°. More preferably, the angle between the first internal cone and the longitudinal centerline of the socket can be substantially or exactly 24°.

The angle between the second internal cone and the longitudinal centerline of the socket can be 28° and 43°. This angle can preferably be between 29° and 439 or between 31° and 34°. The angle between the second internal cone and the longitudinal centerline of the socket can be substantially or exactly 32.5°, as further preferred. Herein, the angle between the second internal cone and the longitudinal centerline of the socket is preferably greater than the angle between the first internal cone and the longitudinal centerline of the socket.

The angle between the first internal cone and the longitudinal centerline of the socket can be between 3° and 11°, preferably between 5° and 9°, particularly preferably between 6° and 8°, and more preferably about or exactly 7° greater than the angle between the first external cone and the longitudinal centerline of the cutting ring.

The angle between the second internal cone and the longitudinal centerline of the socket can be between 4° and 12°, preferably between 5° and 10°, particularly preferably between 6° and 8°, and more preferably about or exactly 6.5° greater than the angle between the second external cone and the longitudinal centerline of the cutting ring.

It may be envisaged that only one single component of the pipe fitting cuts into the pipe in the working position, wherein this component is the cutting ring. Since only a single one-piece component is “responsible” for cutting into the pipe, the pipe fitting can be constructed in a simple and robust manner. It does not rely on a large number of different parts and is easy to produce. Furthermore, such a pipe fitting is very reliable in use.

It may be envisaged that the contact surfaces of the cutting ring and the counter bearing have an inclination to the longitudinal centerlines of the aforementioned components between 81° and 89°, preferably between 83° and 87°, more preferably an inclination between 84° and 86°, particularly preferably of about 85°. On the one hand, the aforementioned inclination causes a force to be applied to the cutting ring during assembly, which acts predominantly along the longitudinal centerlines of the components involved. On the other hand, the slight inclination causes the cutting ring to be bent-up to a certain extent in a spring-like manner during assembly, which has a positive effect on the assembly and the hold of the connection between the pipe fitting and the pipe. For example, the aforementioned bending can support the alignment of the cutting edges with regard to cutting in.

The socket can include a device for connection to other components of a piping system. Preferably, a part of the socket forms the aforementioned device.

The other component can be a second pipe end section, so that two pipes can be connected to each other via their end sections via the socket. Such a socket is preferably symmetrical.

The first external cone can be assigned to the first cutting edge, and the second external cone can be assigned to the second cutting edge.

This assignment can be achieved by providing the aforementioned cones and components in relation to the longitudinal centerlines at least substantially at a height which is at least similar. In any case, this assignment preferably always means that the order of the cutting edges and cones between the first end of the cutting ring and the second end of the cutting ring correspond with each other. Starting from the first end, the first cutting edge and the first external cone thus follow in the direction of the second end, followed by the second cutting edge and the second external cone.

The inner cones can engage operatively with the outer cones directly in the working position. The transmission of forces and the contact between the inner and outer cones is thus preferably performed by direct contact of the surfaces of the respective cones, and is not mediated via intermediate components.

The effective connection of the cones in the working position is preferably achieved by surface contact of the cones mentioned.

The socket, the cutting ring and the hollow screw can each be made of high-alloyed, stainless steel. For example, steels known under the following material designations can be considered herein: 1.4404; 1.4401; 1.4301; 1.4571; 1.4435; 1.4542; 1.4462; 1.4501. Herein, one of the aforementioned materials can be used for the socket, cutting ring and hollow screw. The three components do not necessarily have to be made of the same material.

An outer layer of the cutting ring can be hardened. Surface hardening, in particular surface layer hardening, can be used here.

The threads of the socket and the counter bearing, e.g. of the socket and the hollow screw, can be coated. A solid lubricant can be used here. For example, PTFE or MoS2 can be used.

The pipe with which the pipe fitting is used according to the present invention can be made of the same materials as the socket, cutting ring and hollow screw.

Hereinafter, a use of the pipe fitting described above and a method for the production of a connection between a pipe and such a pipe fitting is described. The features and details described above in relation to the pipe fitting also apply to the use and the method. The features and details described below in relation to the use and the method also apply to the pipe fitting described above.

The present invention also includes a use of at least one embodiment of the pipe fitting described above for the production of a connection between a pipe, preferably between a pipe end section of a pipe, and the pipe fitting. The use also includes, in addition, the production of a connection between the socket and a further component of a pipe system, for example between the socket and a second pipe.

The pipe fitting can be used preferably for conducting fluids at a pressure of up to 4000 bar. Above 4000 bar, there is a risk of the pipe fitting bursting. The pipe fitting is preferably used to conduct fluids at a pressure of 600 bar to 4000 bar, more preferably at a pressure of 600 bar to 2650 bar.

The present invention further comprises a method for the production of a connection between a pipe and at least one embodiment of the pipe fitting described above. The method comprises the following steps:
sliding the counter bearing and the cutting ring onto a pipe end section of the pipe,
Inserting the pipe end section and the cutting ring into the socket,
applying a force to the cutting ring, acting essentially along the longitudinal centerline, through the counter bearing, in order to press the cutting ring into the socket.

Preferably, the counter bearing is first pushed onto the pipe end section of the pipe followed by the cutting ring.

The application of the force to the cutting ring is preferably performed via the contact surfaces of the cutting ring and the counter bearing, and preferably of the cutting ring and the hollow screw. As already described in relation to the pipe fitting, these contact surfaces are preferably inclined at 85° to the longitudinal centerlines of the aforementioned components.

### FIGURE DESCRIPTION

Further advantages, features and details of the invention will become apparent from the subsequent description of preferred embodiments and the drawings, which show in:

FIG. 1 a sectional exploded view of a pipe fitting 1 with a partially shown socket 5;

FIG. 2 a sectional view of a pipe fitting during assembly, i.e. during the production of a connection between a pipe 15 and the pipe fitting 1;

FIG. 3 a sectional view of some of the socket 5;

FIG. 4 a sectional view of some of the pipe fitting 1 according to FIG. 2 immediately after tightening a hollow screw 4;

FIGS. 5 and 6: two variants of a cutting ring 3, 3a in cross-section;

FIGS. 7 to 10: the assembly of the pipe fitting 1 in cross-section;

FIGS. 11 to 14: detailed views according to FIGS. 7 to 10;

FIG. 15 the cutting ring 3 in a sectional view with further details;

FIG. 16 a detailed view of the socket 5 in a sectional view,

FIG. 17 a perspective exploded view of a pipe fitting 1, and

FIG. 18 a sectional view according to FIG. 17.

All figures are schematic. The components shown are not necessarily shown to scale or in proportion to one another.

For the sake of clarity, not all components and features in all figures are provided with reference numbers.

Except for FIG. 6, all figures show the same pipe fitting 1 comprising the same components in essentially the same orientation. Any reference numbers that have been omitted in some figures for the sake of clarity can therefore be added with the help of the other figures.

### Embodiment

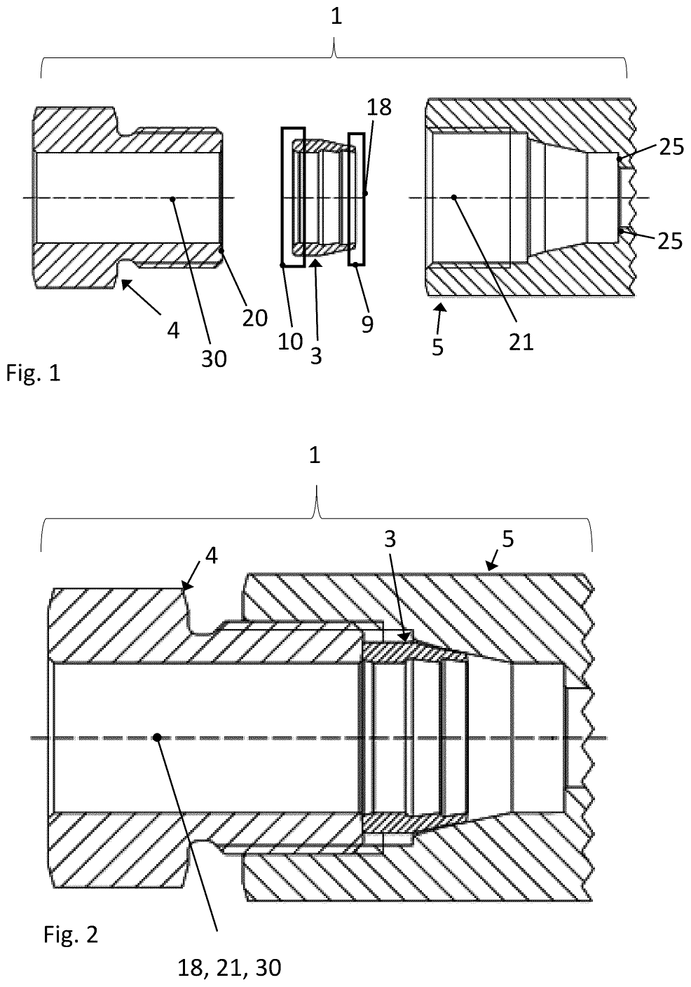

FIG. 1 shows a cutting ring 3, a hollow screw 4 and a socket 5 (only partially shown) as main components of the pipe fitting 1. Furthermore, a stop 5, a first end 9 and a second end 10 of the cutting ring 3, a longitudinal centerline 21 of the socket 5, a longitudinal centerline 18 of the cutting ring 3, a longitudinal centerline 30 of the hollow screw 4, an end stop 25 and a contact surface 20 of the hollow screw 4 are shown.

FIG. 2 shows the components of the pipe fitting 1 according to FIG. 1 during assembly. A pipe 15 is not shown herein for the sake of clarity.

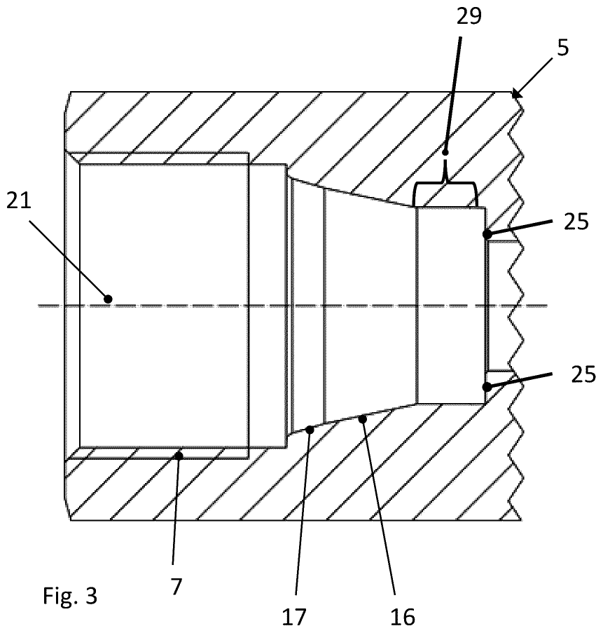

FIG. 3 shows a detailed view of the socket 5 with its longitudinal centerline 21, a first internal cone 16 and a second internal cone 17, as well as an internal thread 7. In addition, a pipe guide section 29 can be seen, at the end of which is the end stop 25.

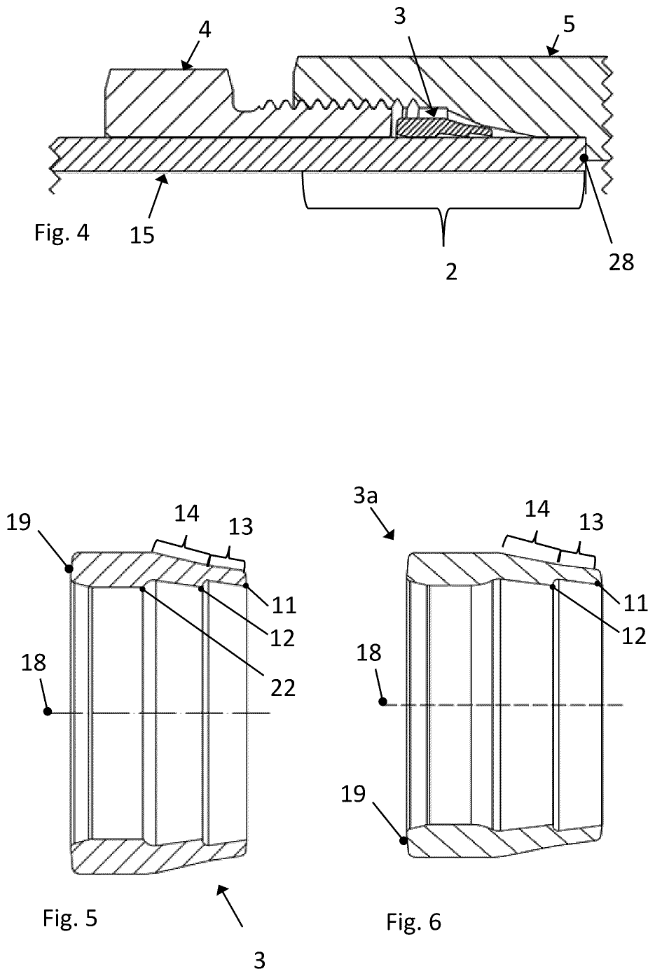

FIG. 4 shows some of the pipe fitting 1 according to FIG. 2 immediately before tightening the hollow screw 4. Here, some of the pipe 15 can be seen with a pipe end section 2 and a pipe end 28. Furthermore, the position of the hollow screw 4 and the cutting ring 3 can be seen immediately before tightening.

FIG. 5 shows the cutting ring 3. Herein, its longitudinal centerline 18, a first external cone 13 and a second external cone 14, as well as a first, a second and a third cutting edge 11, 12, 22 are shown. In addition, a contact surface 19 is shown.

FIG. 6 shows a variant of a cutting ring 3a with only two cutting edges 11, 12. Otherwise, the cutting ring 3a according to FIG. 6 resembles the cutting ring 3 according to FIG. 5.

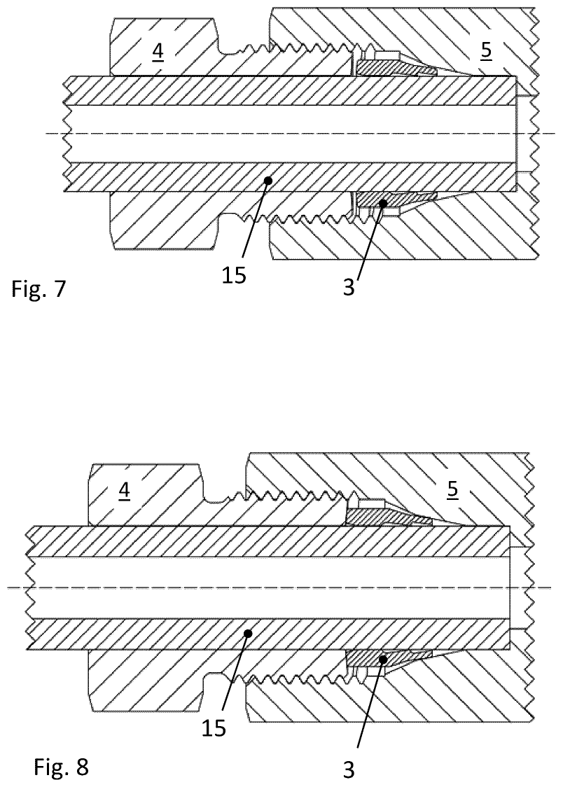

FIG. 7 shows a view of the pipe fitting 1 according to FIG. 4. Here, the pipe 15, the cutting ring 3, the socket 5 and the hollow screw 4 are marked. All the other details and components of the pipe fitting 1, which are marked with reference numbers in FIG. 4, have not been marked with reference numbers in FIG. 7 for the sake of clarity. FIG. 7 shows the pipe fitting 1 at the beginning of the assembly.

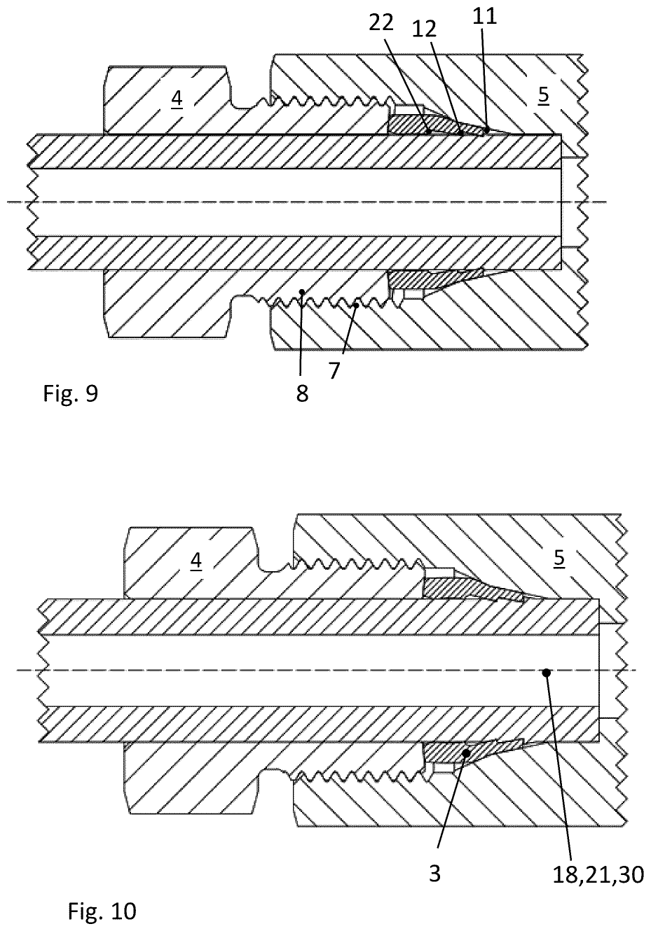

FIG. 8 and FIG. 9 show the pipe fitting 1 according to FIG. 7 during assembly.

FIG. 10 shows the pipe fitting 1 according to FIGS. 7 and 8 after assembly, i.e. in the working position. Herein are shown the longitudinal centerlines 18, 21, 30 of all components 3, 4, 5, which coincide in the working position according to FIG. 10, as well as during the assembly steps according to FIGS. 7 to 9. The same applies to a longitudinal centerline of the pipe 15 that is not provided with a reference number.

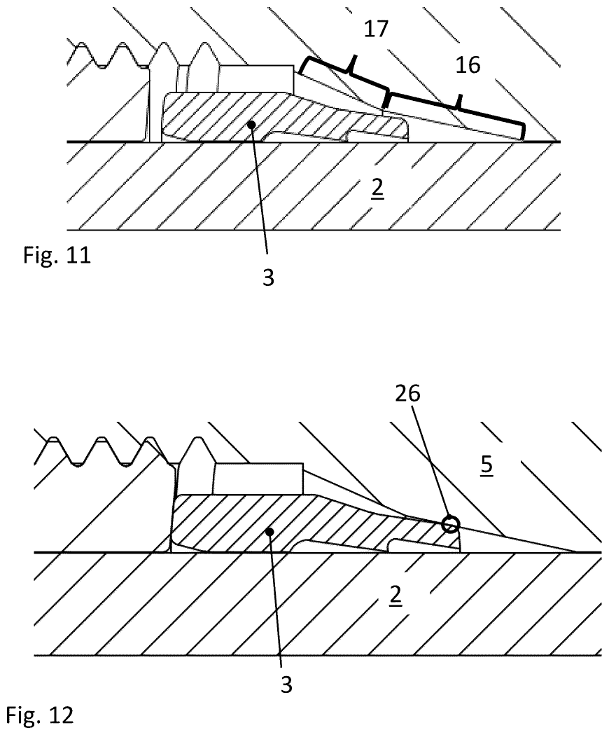

FIG. 11 shows a detailed view of FIG. 7.

FIG. 12 shows a detailed view of FIG. 8.

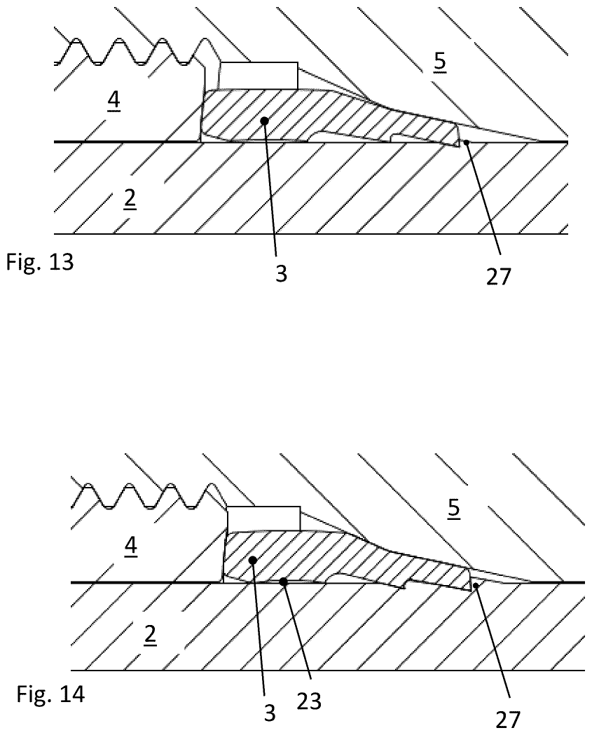

FIG. 13 shows a detailed view of FIG. 9.

FIG. 14 shows a detailed view of FIG. 10.

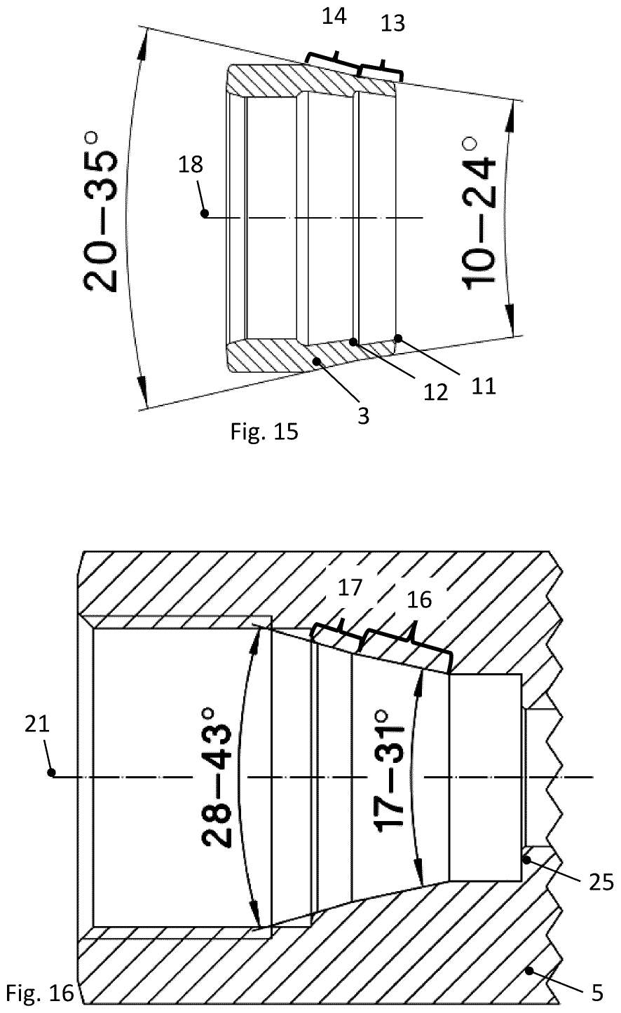

FIG. 15 shows the angles of the outer cones 13, 14 to the longitudinal centerline 18 of the cutting ring 3.

FIG. 16 shows the angles of the inner cones 16, 17 to the longitudinal centerline 21 of the socket 5.

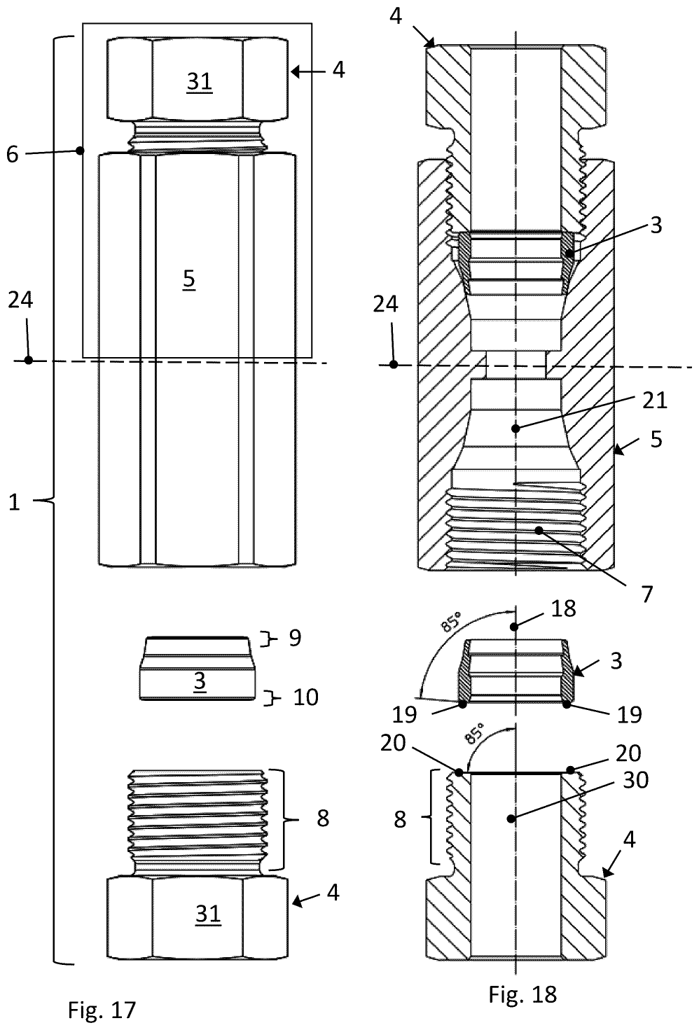

FIG. 17 shows an exploded view of the pipe fitting 1, wherein an axis of symmetry 24 is drawn. In contrast to FIGS. 1, 2, 3, 4, 7 to 10 and 16, FIG. 17 also shows the right part of the socket 5. This right-hand part is designed to hold a cutting ring 3 and a hollow screw 4, as shown in the previous figures for the left-hand part of the socket 5. Furthermore, an external hexagon 31 of the hollow screw 4 is shown, via which the screw can be screwed into the internal thread 7 using a suitable tool.

FIG. 18 shows a sectional view according to FIG. 17. Among other things, the longitudinal centerlines 18, 21, 30 of the three components 3, 5, 4 can be seen. Furthermore, it can be seen from FIG. 18 that the contact surfaces 19, 20 each form an angle of 85° with the longitudinal centerlines 18, 30.

With reference to FIGS. 1 to 18, the mode of operation of the pipe fitting 1 according to the invention and the method according to the invention are explained as follows:

The hollow screw 4 and the cutting ring 3 are pushed onto the pipe end section 2 of the pipe 15. The pipe end section 2 with the cutting ring 3 on it is then inserted into the socket 5 until the pipe end 28 enters the pipe guide section 29. After that, the external thread 8 of the hollow screw 4 can be screwed to the internal thread 7 of the socket 5. In the working position, the pipe end 28 preferably rests against the end stop 25.

Initially, the contact surface 20 of the hollow screw 4 does not yet contact the contact surface 19 of the cutting ring 3, as shown in FIGS. 4, 7 and 11.

If, starting from the position shown in FIGS. 7 and 11, the external thread 8 of the hollow screw 4 is screwed in a little further, the contact surfaces 19, 20 come into contact, to an initial line contact 26 between the cutting ring 3 and the first internal cone 16. This line contact 26 can be seen in the sectional view in FIG. 12 as a point contact indicated by a circle.

If the hollow screw 4 is screwed in further, a section of the first end 9 of the cutting ring 3 slides along the first internal cone 16. In this case, this first end 9 bends towards the pipe end section 2 so that the first cutting edge 11 cuts into the pipe 15. Herein, a bulge 27 is formed, which slows down and impedes further movement of the cutting ring 3 along the pipe end section 2, i.e. to the right in FIGS. 7 to 14. As can be seen in FIGS. 9 and 13, the second cones 14, 17 do not yet contact each other in this situation. The second cutting edge 12 is also not yet cutting into the pipe end section 2. The third cutting edge 22 is also not yet cutting or braking due to contact with the pipe end section 2. However, the first cones 13, 16 are lying flat on top of each other.

If, starting from the situation shown in FIGS. 9 and 13, the hollow screw 4 is screwed further into the internal thread 7, the cutting ring 3 is bent further until the position shown in FIGS. 10 and 14 is reached. Herein, both the first cones 13, 16 and the second cones 14, 17 are in flat contact with each other. The second cutting edge 12 has worked its way into the pipe end section 2. Furthermore, a spring-like bending-open action has produced a bent-up section 23. The third cutting edge 22 rests on the pipe end section 2, which also helps to hold the pipe 15 in position. In this position, the pipe end section 2 and thus the entire pipe 15 are securely fastened in the pipe fitting 1.

From the above, it is clear that the socket 5 is configured to receive and support the pipe end section 2 and the cutting ring 3, as well as to partially receive the hollow screw 4, whose external thread 8 is located in the operating position according to FIG. 10, for example, in the socket.

The first external cone 13 forms a smaller angle with the longitudinal centerline 18 of the cutting ring 3 than the second external cone 14. FIG. 15 shows preferred areas of the aforementioned angles.

The first internal cone 16 forms a smaller angle with the longitudinal centerline 21 of the socket 5 than the second internal cone 17. FIG. 16 shows preferred ranges of the aforementioned angles.

As can be seen, for example, from FIG. 14, the inner cones 16, 17 engage operatively in the working position directly with the outer cones 13, 14, without the need for further intermediate components for making contact and/or force transmission between the aforementioned cones 13, 14, 16, 17.

As already mentioned and also shown in FIGS. 11 to 14, without the angles being shown there, the contact surfaces 19, 20 are preferably inclined at about 85° to the longitudinal centerlines 18, 21. Therefore, the force that the hollow screw 4 transfers to the cutting ring 3 is essentially, but not completely, parallel to the longitudinal centerlines 18, 21. The component of this force that is not parallel to the longitudinal centerlines 18, 21 supports the bending-open of the cutting ring 3, shown in FIGS. 13 and 14, so that the bent-up section 23 is created.

It can be seen from the figures that the longitudinal centerlines 18, 21, 30 are axes of rotational symmetry of the respective components 3, 5, 4.

In particular, FIGS. 11 to 14 show that the cones 13, 14, 16, 17 are dimensioned and arranged in such a way that during the production of the working position, i.e. during assembly, first the first cutting edge 11 and then the second cutting edge 12 cuts into a surface of the pipe end section 2. After the first cutting edge 11 has cut in, as shown in FIG. 13, the bulge 27 forms, which, together with the first cutting edge 11, acts as an anchor to prevent or impede further movement of the cutting ring 3 along the longitudinal centerlines 18, 21, i.e. to the right in FIG. 13. A comparison of FIGS. 13 and 14 shows that a further movement of the hollow screw 4 to the right therefore causes the cutting ring 3 to be deformed, thus forming the bent-up section 23, pressing the first cutting edge 11 even deeper into the surface of the pipe end section 2 and enlarging the bulge 27. In particular, however, the second cutting edge 12 only cuts into the surface of the pipe end section 2 after the first cutting edge 11 has cut in.

If, as is the case with the pipe connection according to AT 270316 B, the second cutting edge 12 were to cut into the surface first, it would act as an anchor. The application of force to the cutting ring 3 by the hollow screw 4 would then push the second cutting edge 12 deeper into the surface, but the first cutting edge 11 would not be able to dig into the surface sufficiently. After the second cutting edge 12 has cut in, a further application of force to the cutting ring 3 by the hollow screw 4 could no longer be transmitted in the desired manner to the section between the second cutting edge 12 and the first end 9 of the cutting ring 3. Therefore, if the second cutting edge 12 were to cut in first, the successful cutting in of the first cutting edge 11 would no longer be guaranteed.

FIGS. 11 to 14 in connection with FIGS. 15 and 16 show that the first cones 13, 16 and the second cones 14, 17 differ in terms of their angle to the respective longitudinal centerline 18, 21. In the working position, the first cones 13, 16 and the second cones 14, 17 nevertheless rest on each other flatly, since the cutting ring 3, starting from FIGS. 7 and 11, deforms accordingly during the production of the working position shown in FIGS. 10 and 14. It is only as a result of this deformation that the aforementioned cones 13, 14, 16, 17 come to rest flat against one another.

FIGS. 10 and 14 show that the pipe fitting 1 is particularly fluid-tight because, on the one hand, the cutting edges 11, 12 have worked themselves into the surface of the pipe end section 2 and, on the other hand, the first cones 13, 16 and also the second cones 14, 17 nestle flat against each other. Fluids that are routed inside the pipe 15 cannot escape between the surface of the pipe end section 2 and the cutting ring 3 or between the cutting ring 3 and the socket 5 in order to leave the pipe connection 1. Herein, it may be sufficient if the first cones 13, 16 and the first cutting edge 11 produce the sealing effect described above.

The first cones 13, 16, i.e. the first internal cone 16 and the first external cone 13, first contact each other during assembly, i.e. before the second cones 14, 17 contact each other. In this process, point or line contact occurs first, followed by sliding contact between the first external cone 13 and the first internal cone 16, until surface contact is formed between the aforementioned cones 13, 16. This can be seen in FIGS. 12 to 14. The second cones 14, 17, i.e. the second internal cone 17 and the second external cone 14, do not contact each other until after the production of the aforementioned surface contact of the first cones 13, 16. The surface contact between the second cones 14, 17 is then preferably achieved by enlarging the angle between the second external cone 14 and the longitudinal centerline 18 of the cutting ring 3 by bending the cutting ring 3. This can be seen from a comparison of FIGS. 13 and 14. Also, in the production of the surface contact between the first cones 13, 16, the angle between the first external cone 13 and the longitudinal centerline 18 of the cutting ring 3 is enlarged, preferably by bending the cutting ring 3, which at least supports the production of the aforementioned surface contact. In particular, the penetration of the cutting edges 11, 12 into the surface of the pipe end section 2 can, in connection with a bending of the cutting ring 3, ensure the production of the surface contacts between the inner and outer cones 13, 14, 16, 17 and vice versa.

Although only some preferred embodiments of the invention have been described and illustrated, it is obvious that a skilled person can add numerous modifications without departing from the essence and scope of the invention.

First of all, it should be emphasized that almost all the components shown in the figures are components of the same pipe fitting 1. Only the cutting ring 3a is a slight modification of the cutting ring 3.

Apart from that, the alternatives described in the subsequent paragraphs but not illustrated in the figures may also be considered.

The cones 13, 14, 16, 17 may differ from the cones shown in FIGS. 1 to 18. Cones 13, 14, 16, 17 of a different design or shape can also ensure that the first cones 13, 16 and the second cones 14, 17 engage operatively in the working position.

The same applies to the cutting edges 11, 12. Cones 13, 14, 16, 17 of a different nature or shape and/or cutting edges 11, 12 of a different nature or differently shaped cutting edges 11, 12 can ensure that during the production of the working position, first the first cutting edge 11 and then the second cutting edge 12 cut into the pipe end section 2 or into its surface.

Instead of the hollow screw 4, another suitable counter bearing can be provided. This is preferably always configured to move the cutting ring 3 into the working position. For this purpose, the counter bearing can, for example, have an internal thread, in deviation from the figures, which corresponds to an external thread of the socket. Further alternatives are conceivable.

The cutting ring 3 and the hollow screw 4 or, in general, the cutting ring 3 and the counter bearing can be performed in one piece as an alternative to the embodiments of FIGS. 1 to 18. Herein, the cutting ring 3 and the counter bearing, for example, the hollow screw 4, can be connected permanently or via a predetermined breaking point. A predetermined breaking point can be used to release the cutting ring 3 from the counter bearing during the screwing-in-process, as shown in FIGS. 8 to 10, for example.

The contact surfaces 19, 20 are preferably inclined at about 85° to the longitudinal centerlines 18, 30. Deviations are conceivable.

With the pipe fitting 1 shown in FIG. 17, two pipes 15 can be connected to one another at their pipe end sections 2. Based on FIG. 17, numerous alternative embodiments can be envisaged, which comprise alternative devices 6 for connection to further components of a piping system. Herein, a symmetry axis 24 is not necessarily present. The socket 5 can therefore be designed differently on the left and right in a modification of the variant shown in FIG. 17.

Preferably, the first cutting edge 11 is assigned to the first external cone 13 and the second cutting edge 12 is assigned to the second external cone 14. As can be seen from FIGS. 1, 5, 6, 9 and 15 in combination, the first cutting edge 11 can be arranged approximately at the height of the first external cone 13 and the second cutting edge 12 approximately at the height of the second external cone 14, with respect to the longitudinal centerline 18. Preferably, the cutting edges 11, 12 are arranged in this case not in the center with respect to the extent of the outer cones 13, 14 along the longitudinal centerline 18, but rather at the edge. They are preferably located on an edge of the cones 13, 14, which is closer to the first end 9 of the cutting ring 3. The second cutting edge 12 can also be shifted a little to the right, based on FIG. 15.

The outer cones 13, 14 and the inner cones 16, 17 are directly adjacent to one another in the embodiments shown in the figures. For example, the second external cone 14 is directly adjacent to the first external cone 13. Alternatively, it may be envisaged that the external cones 13, 14 on the cutting ring 3 and the internal cones 16, 17 in the socket 5 are not arranged directly adjacent to one another, but that a small distance is provided between these cones.

Cutting rings 3, 3a with two external cones 13, 14 and two to three cutting edges 11, 12, 22 are particularly preferred. The third cutting edge 22 is optional herein. It can be incorporated into the pipe end section 2 in addition to the other two cutting edges 11, 12, preferably after the second cutting edge 12. Alternatively, the third cutting edge 22 can only rest on the pipe end section 2 in the working position. If the third cutting edge 22, if present, only rests on the pipe end section 2, it can serve as a supporting edge. Furthermore, as an alternative, the alternative cutting ring 3a can be used in all the variants shown, which has no third cutting edge 22.

With regard to FIGS. 12 to 14, an embodiment can also be considered in which the second cones 14, 17, i.e. the second internal cone 17 and the second external cone 14, are already in contact before the surface contact between the first cones 13, 16 has been fully produced.

FIGS. 1, 5 and 6 show that the first cutting edge 11 preferably forms a section of the first end 9 of the cutting ring 3, 3a or is at least arranged at this first end 9. The contact surface 19 preferably forms the second end 10 of the cutting ring 3, 3a or is arranged at this end 10. Thus, there is no section of the cutting ring 3, 3a between the first end 9 of the cutting ring 3, 3a and that first cutting edge 11 which cuts in first. Alternatives are possible.

### REFERENCE NUMBERS

1—Pipe fitting
2—Pipe end section
3—Cutting ring
4—Hollow screw
5—socket
6—device for connection to other components of a piping system
7—internal thread
8—external thread
9—first end
10—second end
11—first cutting edge
12—second cutting edge
13—first external cone
14—second external cone
15—pipe
16—first internal cone
17—second internal cone
18—longitudinal centerline of the cutting ring
19—contact surface of the cutting ring
20—contact surface of the hollow screw
21—longitudinal centerline of the socket
22—third cutting edge
23—bent-up section
24—Symmetry axis
25—End stop
26—Line contact
27—Bulge
28—Pipe end
29—Pipe guide section
30—Longitudinal centerline of the hollow screw
31—External hexagon

1. A pipe fitting comprising:
a socket,
wherein the socket is configured to receive and hold a pipe end section belonging to a pipe and a cutting ring and to at least partially receive a counter bearing,
wherein the pipe fitting is designed such that the counter bearing and the cutting ring are pushed onto the pipe,
wherein the cutting ring has a first end and a second end, wherein the first end is arranged closer to a pipe end of the pipe than the second end in the working position,
wherein at least two cutting edges are arranged inside the cutting ring, wherein the first cutting edge is arranged closer to the first end than the second cutting edge,
wherein an outer surface of the cutting ring includes at least a first external cone and a second external cone, wherein the first external cone is arranged closer to the first end,
wherein the first external cone is arranged closer to the pipe end in the working position than the second external cone,
wherein the first external cone forms a smaller angle with a longitudinal centerline of the cutting ring than the second external cone,
wherein an inner surface of the socket includes at least a first internal cone and a second internal cone,
wherein the first internal cone forms a smaller angle with a longitudinal centerline of the socket than the second internal cone,
wherein the first internal cone is configured to engage operatively with the first external cone in the working position, and wherein the second internal cone is configured to engage operatively with the second external cone in the working position,
wherein the working position is produced by the counter bearing moving the cutting ring into the socket,
wherein the cones are configured in such a way that during the production of the working position, first the first cutting edge and then the second cutting edge cuts into a surface of the pipe end section.

2. The pipe fitting according to claim 1, wherein the socket has an internal thread which corresponds to an external thread of the counter bearing.

3. The pipe fitting according to claim 1, wherein the pipe fitting comprises the socket, the cutting ring and the counter bearing as separately manufactured components.

4. The pipe fitting according to claim 1, wherein the angle between the first internal cone and the longitudinal centerline of the socket is greater than the angle between the first external cone and the longitudinal centerline of the cutting ring, and that the angle between the second internal cone and the longitudinal centerline of the socket is greater than the angle between the second external cone and the longitudinal centerline of the cutting ring.

5. The pipe fitting according to claim 1, wherein the angle between the first external cone and the longitudinal centerline of the cutting ring is between 10° and 24°, between 13° and 21°, or between 15° and 19°, and that the angle between the second external cone and the longitudinal centerline of the cutting ring is between 20° and 35°, between 22° and 32°, or between 24° and 29°.

6. The pipe fitting according to claim 1, wherein the angle between the first internal cone and the longitudinal centerline of the socket is between 17° and 31°, and that the angle between the second internal cone and the longitudinal centerline of the socket is between 28° and 43°.

7. The pipe fitting according to claim 1, characterized by exactly one single-piece component in the form of the cutting ring which, in the working position, cuts into the pipe.

8. The pipe fitting according to claim 1, wherein the contact surfaces of the cutting ring and of the counter bearing have an inclination to the longitudinal centerlines between 81° and 89°, between 83° and 87°, an inclination between 84° and 86°, or approximately 85°.

9. The pipe fitting according to claim 1, wherein the socket further comprises a device for connection to further components of a piping system.

10. The pipe fitting according to claim 1, wherein the first external cone is assigned to the first cutting edge, and the second external cone is assigned to the second cutting edge.

11. The pipe fitting according to claim 1, wherein the inner cones engage operatively directly with the outer cones in the working position.

12. Use of the pipe fitting according to claim 1 for the production of a connection between the pipe and the pipe fitting.

13. Use of the pipe fitting according to claim 12 for the passage of fluids at a pressure of up to 2650 bar.

14. Method for the production of a connection between the pipe and the pipe fitting according to claim 1, the method comprising:
pushing the counter bearing and the cutting ring onto the pipe end section of the pipe,
inserting the pipe end section and the cutting ring into the socket, and
applying a force to the cutting ring that acts along the longitudinal centerlines through the counter bearing in order to press the cutting ring into the socket.
